(19) United States
(12) Patent Application Publication
(10) Pub. No.: US 2026/0176486 A1
(43) Pub. Date: Jun. 25, 2026

(54) Ink Set And Recording Method

(71) Applicant: SEIKO EPSON CORPORATION, Tokyo (JP)

(72) Inventor: Kenichi SEGUCHI, Okaya (JP)

(21) Appl. No.: 19/426,803

(22) Filed: Dec. 19, 2025

(30) Foreign Application Priority Data
Dec. 20, 2024 (JP) 2024-225495

(51) Int. Cl. C09D 11/40; B41M 5/00; C09D 11/101; C09D 11/107; C09D 11/38; C09D 11/54

(52) U.S. Cl. CPC C09D 11/40; B41M 5/0017; C09D 11/101; C09D 11/107; C09D 11/38; C09D 11/54

(57) ABSTRACT

An ink set includes a primer composition and an ink composition, in which the primer composition contains at least one kind of compound (A) selected from an ether ring-containing polymerizable compound (A-1) and a saturated hydrocarbon ring-containing polymerizable compound (A-2), a content of the compound (A) in the primer composition is 80% by mass or more with respect to a total amount of polymerizable compounds, and the ink composition contains the compound (A).

The present application is based on, and claims priority from JP Application Serial Number 2024-225495, filed Dec. 20, 2024, the disclosure of which is hereby incorporated by reference herein in its entirety.

### BACKGROUND

### 1. Technical Field

The present disclosure relates to an ink set and a recording method.

### 2. Related Art

Ink jet recording methods can record high-definition images using a relatively simple apparatus, and achieve rapid development in various fields. Among them, various studies have been made regarding adhesiveness and the like. For example, JP A-2019-094405 discloses an active energy ray-curable primer ink composition containing an amine-modified epoxy (meth)acrylate as a polymerizable compound.

However, many of primer compositions as disclosed in JP A-2019-094405 are intended to enhance adhesiveness, and while adhesiveness is improved, blocking resistance between the primer compositions and recording media becomes a problem. That is, adhesiveness and blocking resistance are in a trade-off relationship, and a problem still remains in achieving both adhesiveness and blocking resistance.

### SUMMARY

An ink set of the present disclosure includes: a primer composition; and an ink composition, in which the primer composition contains at least one kind of compound (A) selected from an ether ring-containing polymerizable compound (A-1) and a saturated hydrocarbon ring-containing polymerizable compound (A-2), the content of the compound (A) in the primer composition is 80% by mass or more with respect to the total amount of the polymerizable compounds, and the ink composition contains the compound (A).

A recording method of the present disclosure includes applying the primer composition of the ink set onto a recording medium, curing the primer composition applied onto the recording medium to form a primer layer, winding the recording medium on which the primer layer is formed, and ejecting the ink composition of the ink set onto the primer layer to attach the ink composition onto the primer layer.

### BRIEF DESCRIPTION OF THE DRAWINGS

FIG. 1 is a table showing compositions of Preparation Examples 1 to 12.

FIG. 2 is a table showing compositions of Preparation Examples 13 to 20.

FIG. 3 is a table showing results of Examples and Comparative Examples.

### DESCRIPTION OF EMBODIMENTS

An embodiment of the present disclosure (hereinafter, referred to as “the present embodiment”) will be described in detail below. However, embodiments described herein are merely examples for describing the present disclosure, and the present disclosure is not limited thereto. That is, the technical scope of the present disclosure should be determined based on the appended claims, and the present disclosure can be implemented by arbitrarily modifying the following embodiments without departing from the spirit of the present disclosure. In the present specification, for example, the expression of a numerical range of “1 to 100” includes both the lower limit value “1” and the upper limit value “100.” The same applies to expressions of other numerical ranges.

In the present specification, “(meth)acryloyl” means at least one of acryloyl and methacryloyl corresponding thereto, “(meth)acrylate” means at least one of acrylate and methacrylate corresponding thereto, and “(meth)acryl” means at least one of acryl and methacryl corresponding thereto.

### 1. Ink Set

The ink set of the present embodiment includes a primer composition and an ink composition, the primer composition contains at least one kind of compound (A) selected from an ether ring-containing polymerizable compound (A-1) and a saturated hydrocarbon ring-containing polymerizable compound (A-2), the content of the compound (A) in the primer composition is 80% by mass or more with respect to the total amount of the polymerizable compounds, and the ink composition contains the compound (A).

The primer composition of the present embodiment contains a predetermined amount of a predetermined compound (A). A primer layer obtained by curing such a primer composition is excellent in adhesiveness to a recording medium and is also excellent in blocking resistance.

The ink composition of the present embodiment contains the same predetermined compound (A) as the primer composition. An ink layer obtained by curing such an ink composition is excellent in adhesiveness to the primer layer.

Therefore, since the ink set of the present embodiment includes the primer composition and the ink composition, it is possible to achieve both adhesiveness and blocking resistance.

### 1. 1. Primer Composition

The primer composition of the present embodiment contains at least one kind of compound (A) selected from an ether ring-containing polymerizable compound (A-1) and a saturated hydrocarbon ring-containing polymerizable compound (A-2), and the content of the compound (A) in the primer composition is 80% by mass or more with respect to the total amount of the polymerizable compounds.

### 1. 1. 1. Compound (A)

The primer composition of the present embodiment contains at least one kind of compound (A) selected from the ether ring-containing polymerizable compound (A-1) and the saturated hydrocarbon ring-containing polymerizable compound (A-2). Since the primer composition of the present embodiment contains the compound (A), blocking can be suppressed when a recording medium and the primer layer are brought into contact with each other, for example, by winding the recording medium after the primer composition is applied onto the recording medium and cured. When the ink composition is attached to the primer layer, adhesiveness between the primer layer and the ink composition tends to be excellent.

The primer composition of the present embodiment preferably contains the ether ring-containing polymerizable compound (A-1) and the saturated hydrocarbon ring-containing polymerizable compound (A-2). When the ether ring-containing polymerizable compound (A-1) and the saturated hydrocarbon ring-containing polymerizable compound (A-2) are contained, the primer composition of the present embodiment tends to be able to suppress deterioration in adhesiveness due to a change over time or a high temperature. Although the mechanism thereof is not particularly limited, it is presumed that in the case where the two kinds of polymerizable compounds are contained: the ether ring-containing polymerizable compound (A-1) and the saturated hydrocarbon ring-containing polymerizable compound (A-2), compared to the case where one polymerizable compound of the ether ring-containing polymerizable compound (A-1) or the saturated hydrocarbon ring-containing polymerizable compound (A-2) is contained, monomers having different structures are polymerized, whereby shrinkage of a coating film is less likely to occur, and deterioration in adhesiveness due to a change over time or a high temperature is suppressed.

The content of the compound (A) is 80% by mass or more, preferably 85% by mass or more, 90% by mass or more, 95% by mass or more, or 100% with respect to the total amount of the polymerizable compounds. When the content of the compound (A) is 80% by mass or more, there is a tendency to further achieve both adhesiveness to the ink composition and blocking resistance.

### 1. 1. 1. 1. Ether Ring-Containing Polymerizable Compound (A-1)

The ether ring-containing polymerizable compound (A-1) is not particularly limited as long as it is a polymerizable compound having an ether ring in the molecule thereof, and examples thereof include tetrahydrofurfuryl (meth)acrylate, γ-butyrolactone (meth)acrylate, dioxolane (meth)acrylate, dioxane glycol di(meth)acrylate, oxetane (meth)acrylate, (2-methyl-2-ethyl-1,3-dioxolane-4-yl) methyl acrylate (MEDOL-10), and cyclic trimethylolpropane formal (meth)acrylate, which may be used alone or in combination of two or more. Among these, as the ether ring-containing polymerizable compound (A-1), cyclic trimethylolpropane formal (meth)acrylate is preferable, and cyclic trimethylolpropane formal acrylate (CTFA) is more preferable. By using such a compound, there is a tendency to further achieve both adhesiveness and blocking resistance.

The content of the ether ring-containing polymerizable compound (A-1) is preferably 5% by mass or more and 70% by mass or less, 10% by mass or more and 65% by mass or less, and 15% by mass or more and 60% by mass or less with respect to the total amount of the polymerizable compounds. When the content of the ether ring-containing polymerizable compound (A-1) is 5% by mass or more, there is a tendency to further achieve both adhesiveness and blocking resistance, and when the content is 70% by mass or less, there is a tendency to suppress deterioration in adhesiveness due to a change over time or a high temperature.

### 1. 1. 1. 2. Saturated Hydrocarbon Ring-Containing Polymerizable Compound (A-2)

The saturated hydrocarbon ring-containing polymerizable compound (A-2) is not particularly limited as long as it is a polymerizable compound having a saturated hydrocarbon ring in the molecule thereof, and examples thereof include isobornyl methacrylate, isobornyl acrylate (IBXA), tert-butylcyclohexanol acrylate (TBCHA), and 2-(meth)acrylic acid-1,4-dioxaspiro[4.5]dec-2-ylmethyl, which may be used alone or in combination of two or more. Among these, tert-butyl cyclohexanol acrylate (TBCHA) is preferable as the saturated hydrocarbon ring-containing polymerizable compound (A-2). By using such a compound, there is a tendency to further achieve both adhesiveness and blocking resistance. In particular, although adhesiveness may decrease over time, by using the saturated hydrocarbon ring-containing polymerizable compound (A-2) as described above, a decrease in adhesiveness over time can be suppressed.

The content of the saturated hydrocarbon ring-containing polymerizable compound (A-2) is preferably 20% by mass or more and 95% by mass or less, 25% by mass or more and 92% by mass or less, 30% by mass or more and 88% by mass or less, or 38% by mass or more and 85% by mass or less with respect to the total amount of the polymerizable compounds. When the content of the saturated hydrocarbon ring-containing polymerizable compound (A-2) is 20% by mass or more, there is a tendency to further achieve both adhesiveness and blocking resistance, and when the content is 95% by mass or less, there is a tendency to suppress deterioration in adhesiveness due to a change over time or a high temperature.

### 1. 1. 2. Other Polymerizable Compounds

The primer composition of the present embodiment may further contain another polymerizable compound as a polymerizable compound in addition to the compound (A). The other polymerizable compound is not particularly limited, and may be a monofunctional monomer having one polymerizable functional group or a polyfunctional monomer having a plurality of polymerizable functional groups. The other polymerizable compound may include an oligomer having one or two or more polymerizable functional groups. One kind of each polymerizable compound may be used alone, or two or more kinds thereof may be used in combination.

The other monomer is not particularly limited, and a known monomer having a polymerizable functional group, particularly a polymerizable functional group having a carbon-carbon unsaturated double bond, can be used. Examples thereof include an aromatic ring-containing monomer, a nitrogen-containing heterocycle-containing monomer, a non-alicyclic aliphatic group-containing monomer, and a hydroxy group-containing monomer. Among these, as the other monomer, an aromatic ring-containing monomer and/or a nitrogen-containing heterocycle-containing monomer is preferably contained.

### 1. 1. 2. 1. Aromatic Ring-Containing Monomer

The aromatic ring-containing monomer is not particularly limited, and examples thereof include phenoxyethyl (meth)acrylate, benzyl (meth)acrylate, alkoxylated 2-phenoxyethyl (meth)acrylate, ethoxylated nonylphenyl (meth)acrylate, alkoxylated nonylphenyl (meth)acrylate, p-cumylphenol EO-modified (meth)acrylate, and 2-hydroxy-3-phenoxypropyl (meth)acrylate, which may be used alone or in combination of two or more. Among these, benzyl (meth)acrylate is preferably contained as the aromatic ring-containing monomer, and benzyl acrylate (BZA) is more preferably contained.

In the case of containing the aromatic ring-containing monomer, the content of the aromatic ring-containing monomer is preferably 1% by mass or more and 20% by mass or less, 3% by mass or more and 15% by mass or less, or 5% by mass or more and 10% by mass or less with respect to the total amount of the polymerizable compounds. When the content of the aromatic ring-containing monomer falls within the above ranges, adhesiveness tends to be excellent.

### 1. 1. 2. 2. Nitrogen-Containing Heterocycle-Containing Monomer

The nitrogen-containing heterocycle-containing monomer is not particularly limited, and examples thereof include vinylmethyloxazolidinone (VMOX), N-vinylcaprolactam, N-vinylcarbazole, N-vinylpyrrolidone, and acryloylmorpholine (ACMO), which may be used alone or in combination of two or more. Among these, acryloylmorpholine (ACMO) is more preferably contained as the nitrogen-containing heterocycle-containing monomer.

In the case where the nitrogen-containing heterocycle-containing monomer is contained, the content of the nitrogen-containing heterocycle-containing monomer is preferably 1% by mass or more and 20% by mass or less, 3% by mass or more and 15% by mass or less, or 5% by mass or more and 10% by mass or less based on the total amount of the polymerizable compounds. When the content of the nitrogen-containing heterocycle-containing monomer falls within the above ranges, adhesiveness tends to be excellent.

### 1. 1. 2. 3. Oligomer

The oligomer is a multimer containing a polymerizable compound as a constituent, and refers to a compound having one or two or more polymerizable functional groups. The polymerizable compound herein is not limited to the above-described monofunctional monomer and polyfunctional monomer. In the present embodiment, a compound having a molecular weight of 1000 or more is defined as an oligomer, and a compound having a molecular weight of 1000 or less is defined as a monomer.

Such an oligomer is not particularly limited, and examples thereof include a urethane acrylate oligomer having a urethane repeating structure, a polyester acrylate oligomer having an ester repeating structure, and an epoxy acrylate oligomer having an epoxy repeating structure.

Among these, a urethane acrylate oligomer is preferable, an aliphatic urethane acrylate oligomer and an aromatic urethane acrylate oligomer are more preferable, and an aliphatic urethane acrylate oligomer is still more preferable. The urethane acrylate oligomer is preferably a urethane acrylate oligomer having four or less functional groups, and more preferably a urethane acrylate oligomer having two functional groups. By using such an oligomer, the viscosity tends to be further decreased, and abrasion resistance and the like tend to be further improved.

When the oligomer is used, the content thereof is preferably 0% to 10% by mass, 0.5% to 5% by mass, or from 1% to 3% by mass with respect to the total amount of the composition. When the content of the oligomer falls within the above ranges, the viscosity tends to be further decreased, and abrasion resistance and the like tend to be further improved.

### 1. 1. 3. Photopolymerization Initiator

The primer composition of the present embodiment may further contain a photopolymerization initiator. One kind of the photopolymerization initiator may be used alone, or two or more kinds thereof may be used in combination.

The photopolymerization initiator is not particularly limited as long as it generates an active species by irradiation with radiation, and examples thereof include known photopolymerization initiators such as an acylphosphine oxide-based photopolymerization initiator, an alkylphenone-based photopolymerization initiator, a titanocene-based photopolymerization initiator, and a thioxanthone-based photopolymerization initiator. Among these, the photopolymerization initiator preferably contains an acylphosphine oxide-based photopolymerization initiator and/or a thioxanthone-based photopolymerization initiator, and more preferably contains an acylphosphine oxide-based photopolymerization initiator and a thioxanthone-based photopolymerization initiator. By using such a photopolymerization initiator, curability of the primer composition is further improved, and adhesiveness and blocking resistance tend to be excellent.

The acylphosphine oxide-based photopolymerization initiator is not particularly limited, and examples thereof include 2,4,6-trimethylbenzoyl diphenyl phosphineoxide, bis(2,4,6-trimethylbenzoyl)-phenyl phosphineoxide, bis-(2,6-dimethoxybenzoyl)-2,4,4-trimethylpentyl phosphineoxide, and ethyl phenyl (2,4,6-trimethylbenzoyl) phosphinate.

Examples of commercially available products of the acylphosphine oxide-based photopolymerization initiator include IRGACURE 819 (bis(2,4,6-trimethylbenzoyl)-phenylphosphineoxide), IRGACURE 1800 (a mixture of bis-(2,6-dimethoxybenzoyl)-2,4,4-trimethylpentylphosphineoxide and 1-hydroxy-cyclohexyl-phenylketone at a weight ratio of 25:75), IRGACURE TPO (2,4,6-trimethylbenzoyldiphenylphosphineoxide), and IRGACURE TPO-L (ethyl phenyl (2,4,6-trimethylbenzoyl) phosphinate) (all manufactured by BASF SE).

The thioxanthone-based photopolymerization initiator is not particularly limited, and examples thereof include thioxanthone, 2-methylthioxanthone, 2,4-diethylthioxanthone, 2-isopropylthioxanthone, 4-isopropylthioxanthone, 2-chlorothioxanthone, and 2,4-diethylthioxanthone. In addition, thioxanthone-based photopolymerization initiators having a molecular weight of 500 or more, such as 1,3-di({α-[1-chloro-9-oxo-9H-thioxanthen-4-yl)oxy]acetylpoly[oxy(1-methylethylene)]}oxy)-2,2-bis({α-[1-chloro-9-oxo-9H-thioxanthen-4-yl)oxy]acetylpoly[oxy(1-methylethylene)]}oxymethyl)propane (CAS registry number: No. 1003567-83-6) and α-[2-[(9-oxo-9H-thioxanthenyl)oxy]acetyl]-ω-[2-[(9-oxo-9H-thioxanthenyl)oxy]acetyl]oxy]poly(oxy-1,4-butanediyl (CAS registry number: No. 813452-37-8), and other are also included. These photopolymerization initiators are preferable from the viewpoint that odors of a coating film can be reduced.

Examples of commercially available products of the thioxanthone-based photopolymerization initiator include KAYACURE DETX-S (2,4-diethylthioxanthone, trade name, manufactured by NIPPON KAYAKU CO., LTD.), Speedcure DETX (2,4-diethylthioxanthone, trade name, manufactured by LAMBSON), and KAYACURE ITX (2-/4-isopropylthioxanthone, trade name, manufactured by NIPPON KAYAKU CO., LTD.).

The content of the photopolymerization initiator is not particularly limited, but is preferably 1% by mass or more, 3% by mass or more, 4% by mass or more, or 5% by mass or more with respect to the total amount of the primer composition. The upper limit of the content of the photopolymerization initiator is not particularly limited, and may be 15% by mass or less. When the content of the photopolymerization initiator falls within the above ranges, curability of the primer composition is further improved, and adhesiveness and blocking resistance tend to be excellent.

When the acylphosphine oxide-based photopolymerization initiator is contained as the photopolymerization initiator, the content thereof is preferably 1% by mass or more and 15% by mass or less, 2% by mass or more and 10% by mass or less, 3% by mass or more and 8% by mass or less, or 5% by mass or more and 7% by mass or less with respect to the total amount of the primer composition. When the content of the acylphosphine oxide-based photopolymerization initiator falls within the above ranges, the curability of the primer composition is further improved, and adhesiveness and blocking resistance tend to be excellent.

In the case where the thioxanthone-based photopolymerization initiator is contained as the photopolymerization initiator, the content thereof is preferably 0.1% by mass or more and 10% by mass or less, 0.2% by mass or more and 5% by mass or less, 0.3% by mass or more and 3% by mass or less, or 0.5% by mass or more and 2.5% by mass or less with respect to the total amount of the primer composition. When the content of the thioxanthone-based photopolymerization initiator falls within the above ranges, curability of the primer composition is further improved, and adhesiveness and blocking resistance tend to be excellent.

### 1. 1. 4. Polymerization Inhibitor

The primer composition of the present embodiment may further contain a polymerization inhibitor. One kind of the polymerization inhibitor may be used alone, or two or more kinds thereof may be used in combination.

Examples of the polymerization inhibitor include, but are not limited to, p-methoxyphenol, hydroquinone monomethyl ether (MEHQ), 4-hydroxy-2,2,6,6-tetramethylpiperidine-N-oxyl, hydroquinone, cresol, t-butylcatechol, 3,5-di-t-butyl-4-hydroxytoluene, 2,2′-methylenebis(4-methyl-6-t-butylphenol), 2,2′-methylenebis(4-ethyl-6-butylphenol), and 4,4′-thiobis(3-methyl-6-t-butylphenol), bis(2,2,6,6-tetramethyl-4-piperidyl-1-oxyl)sebacate (BisTEMPO sebacate), and a hindered amine compound.

The content of the polymerization inhibitor is preferably 0.05% to 1% by mass and more preferably 0.05% to 0.5% by mass with respect to the total amount of the ink composition.

### 1. 1. 5. Other Additives

The primer composition of the present embodiment may contain other additives as long as effects of the present embodiment are not impaired. As other additives, for example, various known additives such as a viscosity modifier, an antioxidant, an ultraviolet absorber, a rust inhibitor, a corrosion inhibitor, and a chelating agent may be contained.

The primer composition of the present embodiment is preferably free of a surfactant, but in the case of containing a surfactant, the content thereof is preferably 0.25% by mass or less, 0.10% by mass or less, 0.03% by mass or less, or 0.01% by mass or less with respect to the total amount of the primer composition. The lower limit of the content of the surfactant is not particularly limited, and is preferably as low as possible, and the surfactant may not be contained (0% by mass). When the content of the surfactant is more than 0.25% by mass, adhesiveness to the ink composition tends to deteriorate. On the other hand, as the content of the surfactant is lower, adhesiveness to the ink composition tends to be improved.

The primer composition of the present embodiment is preferably free of a coloring material, but in the case of containing a coloring material, the content thereof is preferably 1% by mass or less, 0.5% by mass or less, 0.3% by mass or less, or 0.1% by mass or less with respect to the total amount of the primer composition. The lower limit of the content of the coloring material is not particularly limited, but is preferably as low as possible, and the coloring material may not be contained (0% by mass).

### 1. 2. Ink Composition

The ink composition of the present embodiment contains the compound (A). By containing the compound (A), the ink composition of the present embodiment is excellent in compatibility with the primer composition similarly containing the compound (A), and excellent in adhesiveness between a primer layer obtained by curing the primer composition and the ink composition.

### 1. 2. 1. Compound (A)

As the compound (A) contained in the ink composition, the ether ring-containing polymerizable compound (A-1) and the saturated hydrocarbon ring-containing polymerizable compound (A-2) exemplified for the primer composition can be used. The compound (A) contained in the ink composition and the compound (A) contained in the primer composition may be the same or different. When the compound (A) is the same, compatibility between the ink and the primer tends to be more preferable.

The content of the compound (A) is not particularly limited, but is preferably 1% by mass or more, 5% by mass or more, or 10% by mass or more, and preferably 15% by mass or more with respect to the total amount of the ink composition. The upper limit of the content of the compound (A) is not particularly limited, and is preferably 45% by mass or less, 40% by mass or less, or 35% by mass or less. When the content of the compound (A) falls within the above ranges, adhesiveness to the primer layer tends to be excellent.

The content of the ether ring-containing polymerizable compound (A-1) is preferably 5% by mass or more and 40% by mass or less, 7% by mass or more and 30% by mass or less, or 10% by mass or more and 20% by mass or less with respect to the total amount of the polymerizable compounds. When the content of the ether ring-containing polymerizable compound (A-1) falls within the above ranges, adhesiveness to the primer layer tends to be excellent.

The content of the saturated hydrocarbon ring-containing polymerizable compound (A-2) is preferably 5% by mass or more and 40% by mass or less, 7% by mass or more and 30% by mass or less, or 10% by mass or more and 20% by mass or less with respect to the total amount of the polymerizable compounds. When the content of the saturated hydrocarbon ring-containing polymerizable compound (A-2) falls within the above ranges, adhesiveness to the primer layer tends to be excellent.

### 1. 2. 2. Other Monomers

The ink composition of the present embodiment may further contain another monomer as a polymerizable compound in addition to the compound (A). As a monofunctional monomer, a monofunctional monomer having one polymerizable functional group or a polyfunctional monomer having a plurality of polymerizable functional groups may be contained without no particular limitations. One kind of each monomer may be used alone, or two or more kinds thereof may be used in combination.

### 1. 2. 2. 1. Monofunctional Monomer

The monofunctional monomer is not particularly limited, and examples thereof include an aromatic ring-containing monomer, a nitrogen-containing heterocycle-containing monomer, a linear or branched aliphatic group-containing monomer, and a hydroxy group-containing monomer. Among these, an aromatic ring-containing monomer and/or a hydroxy group-containing monomer are preferably contained as the monofunctional monomer.

The content of the monofunctional monomer is not particularly limited, and is preferably 50% by mass or more, 60% by mass or more, 70% by mass or more, or 80% by mass or more with respect to the total amount of the polymerizable compounds. The upper limit of the content of the monofunctional monomer is not particularly limited, and may be 95% by mass or less. When the content of the monofunctional monomer falls within the above ranges, a flexible cured product is obtained when the ink composition is cured, and the ink composition tends to have high adhesiveness even to a thin and flexible recording medium.

### 1. 2. 2. 1. 1. Aromatic Ring-Containing Monomer

The aromatic ring-containing monomer is not particularly limited, and for example, those described in “1. 1. 2. 1. Aromatic ring-containing monomer” may be used. Among the aromatic ring-containing monomers described above, the ink composition of the present embodiment preferably contains phenoxyethyl (meth)acrylate or benzyl acrylate, and more preferably contains phenoxyethyl acrylate (PEA). By using such an aromatic ring-containing monomer, adhesiveness and curability of a coating film tend to be improved.

The content of the aromatic ring-containing monomer is not particularly limited, and is preferably 10% by mass or more and 60% by mass or less, 15% by mass or more and 45% by mass or less, 20% by mass or more and 40% by mass or less, or 25% by mass or more and 35% by mass or less with respect to the total amount of the polymerizable compounds. When the content of the aromatic ring-containing monomer falls within the above ranges, adhesiveness to the primer layer tends to be excellent.

### 1. 2. 2. 1. 2. Hydroxy Group-Containing Monomer

The ink composition of the present embodiment preferably contains a hydroxy group-containing monomer. The hydroxy group-containing monomer is not particularly limited, and may be a hydroxy group-containing monofunctional monomer having one polymerizable functional group or a hydroxy group-containing polyfunctional monomer having a plurality of polymerizable functional groups, and is preferably a hydroxy group-containing monofunctional monomer. One kind of the hydroxy group-containing monomer may be used alone, or two or more kinds thereof may be used in combination.

The hydroxy group-containing monomer is not particularly limited, and examples thereof include hydroxyalkyl methacrylates such as 2-hydroxyethyl (meth)acrylate, 2-hydroxypropyl (meth)acrylate, 3-hydroxypropyl (meth)acrylate, 3-hydroxybutyl (meth)acrylate, and 4-hydroxybutyl (meth)acrylate. Among these, the ink composition of the present embodiment preferably contains 4-hydroxybutyl (meth)acrylate, and more preferably contains 4-hydroxybutyl acrylate (4-HBA). By using such a hydroxy group-containing monomer, adhesiveness to the primer layer tends to be improved.

The content of the hydroxy group-containing monomer is not particularly limited, and is preferably 1% by mass or more and 50% by mass or less, 3% by mass or more and 40% by mass or less, 5% by mass or more and 30% by mass or less, or 10% by mass or more and 20% by mass or less with respect to the total amount of the polymerizable compounds. When the content of the hydroxy group-containing monomer falls within the above ranges, adhesiveness to the primer layer tends to be excellent.

### 1. 2. 2. 2. Polyfunctional Monomer

The ink composition of the present embodiment may further contain a polyfunctional monomer. Examples of the polyfunctional monomer include, but are not limited to, a vinyl ether group-containing (meth)acrylate and a polyfunctional (meth)acrylate.

1. 2. 2. 2. 1. Vinyl Ether Group-Containing (meth)acrylate

The vinyl ether group-containing (meth)acrylate is not particularly limited, and examples thereof include a compound represented by the following formula (1). When such a vinyl ether group-containing (meth)acrylate is contained, the viscosity of the composition decreases, and ejection stability tends to be further improved. In addition, curability of the composition is further improved, and along with improvement of curability, recording speed can be further increased.

CH₂═CR¹—COOR²—O—CH═CH—R³ (1)

(In the formula, R¹ is a hydrogen atom or a methyl group, R² is a divalent organic residue having 2 to 20 carbon atoms, and R³ is a hydrogen atom or a monovalent organic residue having 1 to 11 carbon atoms.)

In the above formula (1), examples of the divalent organic residue having 2 to 20 carbon atoms represented by R² include a linear, branched, or cyclic alkylene group having 2 to 20 carbon atoms, which may be substituted; an alkylene group having 2 to 20 carbon atoms and having an oxygen atom through an ether bond and/or an ester bond in the structure, which may be substituted; and a divalent aromatic group having 6 to 11 carbon atoms which may be substituted. Among these, an alkylene group having 2 to 6 carbon atoms such as an ethylene group, an N-propylene group, an isopropylene group, and a butylene group, and an alkylene group having 2 to 9 carbon atoms and having an oxygen atom through an ether bond in the structure such as an oxyethylene group, an oxy-n-propylene group, an oxyisopropylene group, and an oxybutylene group are preferable. Furthermore, from the viewpoints that the viscosity of the composition can be further reduced and curability of the composition is further improved, a compound having a glycol ether chain in which R² is an alkylene group having 2 to 9 carbon atoms and having an oxygen atom in an ether bond in a structure, such as an oxyethylene group, an oxy-n-propylene group, an oxyisopropylene group, or an oxybutylene group, is more preferable.

In the above formula (1), as the monovalent organic residue having 1 to 11 carbons represented by R³, a linear, branched, or cyclic alkyl group having 1 to 10 carbon atoms, which may be substituted, and an aromatic group having 6 to 11 carbon atoms, which may be substituted, are preferable. Among these, an alkyl group having 1 or 2carbon atoms, which is a methyl group or an ethyl group, and an aromatic group having 6 to 8 carbon atoms, such as a phenyl group and a benzyl group, are preferably used.

In the case where each of the above-described organic residues is a group which may be substituted, substituents thereof are divided into a group that contains a carbon atom and a group that contains no carbon atom. First, in the case of a substituent that is a group containing a carbon atom, the carbon atom is counted as the number of carbon atoms of the organic residue. Although the group containing a carbon atom is not limited to the following groups, examples thereof include a carboxy group and an alkoxy group. Next, although the group that contains no carbon atom is not limited to the following groups, examples thereof include a hydroxy group and a halogen group.

Specific examples of the compound of formula (1) include, but are not particularly limited to, 2-vinyloxyethyl (meth)acrylate, 3-vinyloxypropyl (meth)acrylate, 1-methyl-2-vinyloxyethyl (meth)acrylate, 2-vinyloxypropyl (meth)acrylate, 4-vinyloxybutyl (meth)acrylate, 1-methyl-3-vinyloxypropyl (meth)acrylate, 1-vinyloxymethylpropyl (meth)acrylate, 2-methyl-3-vinyloxypropyl (meth)acrylate, 1,1-dimethyl-2-vinyloxyethyl (meth)acrylate, 3-vinyloxybutyl (meth)acrylate, 1-methyl-2-vinyloxypropyl (meth)acrylate, 2-vinyloxybutyl (meth)acrylate, 4-vinyloxycyclohexyl (meth)acrylate, 6-vinyloxyhexyl (meth)acrylate, 4-vinyloxymethylcyclohexylmethyl (meth)acrylate, 3-vinyloxymethylcyclohexylmethyl (meth)acrylate, 2-vinyloxymethylcyclohexylmethyl (meth)acrylate, p-vinyloxymethylphenylmethyl (meth)acrylate, m-vinyloxymethylphenylmethyl (meth)acrylate, o-vinyloxymethylphenylmethyl (meth)acrylate, 2-(2-vinyloxyethoxy)ethyl (meth)acrylate, 2-(2-vinyloxyethoxy)ethyl acrylate (VEEA), 2-(vinyloxyisopropoxy)ethyl (meth)acrylate, 2-(vinyloxyethoxy)propyl (meth)acrylate, 2-(vinyloxyethoxy)isopropyl (meth)acrylate, 2-(vinyloxyisopropoxy)propyl (meth)acrylate, 2-(vinyloxyisopropoxy)isopropyl (meth)acrylate, 2-(vinyloxyethoxyethoxy)ethyl (meth)acrylate, 2-(vinyloxyethoxyisopropoxy)ethyl (meth)acrylate, 2-(vinyloxyisopropoxyethoxy)ethyl (meth)acrylate, 2-(vinyloxyisopropoxyisopropoxy)ethyl (meth)acrylate, 2-(vinyloxyethoxyethoxy)propyl (meth)acrylate, 2-(vinyloxyethoxyisopropoxy)propyl (meth)acrylate, 2-(vinyloxyisopropoxyethoxy)propyl (meth)acrylate, 2-(vinyloxyisopropoxyisopropoxy)propyl (meth)acrylate, 2-(vinyloxyethoxyethoxy)isopropyl (meth)acrylate, 2-(vinyloxyethoxyisopropoxy)isopropyl (meth)acrylate, 2-(vinyloxyisopropoxyethoxy)isopropyl (meth)acrylate, 2-(vinyloxyisopropoxyisopropoxy)isopropyl (meth)acrylate, 2-(vinyloxyethoxyethoxyethoxy)ethyl (meth)acrylate, 2-(vinyloxyethoxyethoxyethoxyethoxy)ethyl (meth)acrylate, 2-(isopropenoxyethoxy)ethyl (meth)acrylate, 2-(isopropenoxyethoxyethoxy)ethyl (meth)acrylate, 2-(isopropenoxyethoxyethoxyethoxy)ethyl (meth)acrylate, 2-(isopropenoxyethoxyethoxyethoxyethoxy)ethyl (meth)acrylate, polyethylene glycol monovinyl ether (meth)acrylate, and polypropylene glycol monovinyl ether (meth)acrylate. Among these specific examples, 2-(2-vinyloxyethoxy)ethyl acrylate (VEEA) is particularly preferable in that curability and viscosity of the composition can be easily balanced.

The content of the vinyl ether group-containing (meth)acrylate is preferably 0.1% to 30% by mass, 1% to 20% by mass, or 3% to 10% by mass with respect to the total amount of the ink composition. When the content of the vinyl ether group-containing (meth)acrylate falls within the above ranges, there is a tendency that storage stability of the ink composition is excellent, the viscosity of the composition decreases, and ejection stability is further improved.

1. 2. 2. 2. 2. Polyfunctional (meth)acrylate

The polyfunctional (meth)acrylate is not particularly limited, and examples thereof include bifunctional (meth)acrylates such as dipropylene glycol diacrylate (DPGDA), diethylene glycol di(meth)acrylate, triethylene glycol di(meth)acrylate, tetraethylene glycol di(meth)acrylate, polyethylene glycol di(meth)acrylate, dipropylene glycol dimethacrylate, tripropylene glycol di(meth)acrylate (TPGDA), polypropylene glycol di(meth)acrylate, 1,4-butanediol di(meth)acrylate, 1,6-hexanediol di(meth)acrylate, 1,9-nonanediol di(meth)acrylate, neopentyl glycol di(meth)acrylate, dimethylol-tricyclodecane di(meth)acrylate, bisphenol A-ethylene oxide (EO) adduct di(meth)acrylate, bisphenol A-propylene oxide (PO) adduct di(meth)acrylate, hydroxypivalic acid neopentyl glycol di(meth)acrylate, and polytetramethylene glycol di(meth)acrylate; and polyfunctional (meth)acrylates having three or more functional groups such as trimethylolpropane tri(meth)acrylate, EO-modified trimethylolpropane tri(meth)acrylate, pentaerythritol tri(meth)acrylate, pentaerythritol tetra(meth)acrylate, dipentaerythritol hexa(meth)acrylate (ADPH), ditrimethylolpropane tetra(meth)acrylate, glyceryl propoxy tri(meth)acrylate, caprolactone-modified trimethylolpropane tri(meth)acrylate, pentaerythritol ethoxy tetra(meth)acrylate, and caprolactam-modified dipentaerythritol hexa(meth)acrylate. Among these specific examples, dipropylene glycol diacrylate (DPGDA) is particularly preferable from the viewpoint of excellent adhesiveness of the ink composition.

The content of the polyfunctional (meth)acrylate is preferably 1% to 50% by mass, 2% to 30% by mass, 3% to 20% by mass, or 5% to 15% by mass with respect to the total amount of the ink composition. When the content of the polyfunctional (meth)acrylate falls within the above ranges, adhesiveness of a coating film tends to be improved.

### 1. 2. 3. Oligomer

The ink composition of the present embodiment may further contain an oligomer as a polymerizable compound in addition to the compound (A).

The oligomer is not particularly limited, and examples thereof include a urethane acrylate oligomer having a urethane repeating structure, a polyester acrylate oligomer having an ester repeating structure, and an epoxy acrylate oligomer having an epoxy repeating structure.

Among these, a urethane acrylate oligomer is preferable, an aliphatic urethane acrylate oligomer and an aromatic urethane acrylate oligomer are more preferable, and an aliphatic urethane acrylate oligomer is still more preferable. The urethane acrylate oligomer is preferably a urethane acrylate oligomer having four or less functional groups, and more preferably a urethane acrylate oligomer having two functional groups. By using such an oligomer, the viscosity tends to be further decreased, and abrasion resistance and the like tend to be further improved.

When the oligomer is used, the content thereof is preferably 0% to 10% by mass, 0.5% to 5% by mass, or from 1% to 3% by mass with respect to the total amount of the composition. When the content of the oligomer falls within the above ranges, the viscosity tends to be further decreased, and abrasion resistance and the like tend to be further improved.

### 1. 2. 4. Photopolymerization Initiator

The ink composition of the present embodiment preferably further contains a photopolymerization initiator. The photopolymerization initiator is not particularly limited, and for example, those described in “1. 1. 3. Photopolymerization initiator” can be used. Among these, the photopolymerization initiator preferably includes an acylphosphine oxide-based photopolymerization initiator and/or a thioxanthone-based photopolymerization initiator, and more preferably includes an acylphosphine oxide-based photopolymerization initiator and a thioxanthone-based photopolymerization initiator. By using such a photopolymerization initiator, curability of the ink composition tends to be further improved, and adhesiveness to the primer layer tends to be excellent.

The content of the photopolymerization initiator is not particularly limited, and is preferably 1% by mass or more, 5% by mass or more, 10% by mass or more, or 12% by mass or more with respect to the total amount of the primer composition. The upper limit of the content of the photopolymerization initiator is not particularly limited, and may be 20% by mass or less. When the content of the photopolymerization initiator falls within the above ranges, curability of the ink composition tends to be further improved, and adhesiveness to the primer layer tends to be excellent.

In the case where the acylphosphine oxide-based photopolymerization initiator is contained as the photopolymerization initiator, the content thereof is preferably 2% by mass or more and 18% by mass or less, 4% by mass or more and 16% by mass or less, and 5% by mass or more and 12% by mass or less with respect to the total amount of the ink composition. When the content of the acylphosphine oxide-based photopolymerization initiator falls within the above ranges, curability of the ink composition tends to be further improved, and adhesiveness to the primer layer tends to be excellent.

In the case where the thioxanthone-based photopolymerization initiator is contained as the photopolymerization initiator, the content thereof is preferably 0.5% by mass or more and 8% by mass or less, 1% by mass or more and 7% by mass or less, 2% by mass or more and 6% by mass or less, and 3% by mass or more and 5% by mass or less with respect to the total amount of the ink composition. When the content of the thioxanthone-based photopolymerization initiator falls within the above ranges, curability of the ink composition tends to be further improved, and adhesiveness to the primer layer tends to be excellent.

### 1. 2. 5. Other Additives

The ink composition according to the present embodiment may contain other additives as long as effects of the present embodiment are not impaired. For example, various known additives such as a polymerization inhibitor, a slip agent, a dispersant, a coloring material, and a fluorescent brightener may be contained.

1. 2. 5. 1. Polymerization In hibitor

The primer composition of the present embodiment may further contain a polymerization inhibitor. One kind of the polymerization inhibitor may be used alone, or two or more kinds thereof may be used in combination.

Examples of the polymerization inhibitor include, but are not limited to, p-methoxyphenol, hydroquinone monomethyl ether (MEHQ), 4-hydroxy-2,2,6,6-tetramethylpiperidine-N-oxyl, hydroquinone, cresol, t-butylcatechol, 3,5-di-t-butyl-4-hydroxytoluene, 2,2′-methylenebis(4-methyl-6-t-butylphenol), 2,2′-methylenebis(4-ethyl-6-butylphenol), and 4,4′-thiobis(3-methyl-6-t-butylphenol), bis(2,2,6,6-tetramethyl-4-piperidyl-1-oxyl)sebacate (BisTEMPO sebacate), and a hindered amine compound.

The content of the polymerization inhibitor is preferably 0.05% to 1% by mass and more preferably 0.05% to 0.5% by mass with respect to the total amount of the ink composition.

### 1. 2. 5. 2. Slip Agent

The ink composition according to the present embodiment may further include a slip agent. One kind of the slip agent may be used alone, or two or more kinds thereof may be used in combination.

As the slip agent, a silicone-based surfactant is preferable, and polyester-modified silicone or polyether-modified silicone is more preferable. Examples of the polyester-modified silicone include BYK-347, 348, BYK-UV 3500, 3510, and 3530 (all manufactured by BYK Additives & Instruments), and examples of the polyether-modified silicone include BYK-3570 (manufactured by BYK Additives & Instruments).

The content of the slip agent is preferably 0.01% to 2% by mass or 0.05% to 1% by mass with respect to the total amount of the ink composition.

### 1. 2. 5. 3. Dispersant

The ink composition of the present embodiment may further contain a dispersant in order to further improve dispersibility of a coloring material and the like. One kind of the dispersant may be used alone, or two or more kinds thereof may be used in combination.

The dispersant is not particularly limited, and examples thereof include dispersants that are commonly used to prepare pigment dispersion liquids, such as a polymer dispersant. Specific examples thereof include those containing, as a main component, one or more of a polyoxyalkylene polyalkylene polyamine, a vinyl-based polymer and copolymer, an acrylic polymer and copolymer, polyester, polyamide, polyimide, polyurethane, an amino-based polymer, a silicon-containing polymer, a sulfur-containing polymer, a fluorine-containing polymer, and an epoxy resin.

Examples of commercially available products of the polymer dispersant include AJISPER series manufactured by Ajinomoto Fine-Techno Co., Inc., Solsperse series (Solsperse 36000 and the like) available from Avecia or Noveon, DISPERBYK series manufactured by BYK Additives & Instruments, and DISPARLON series manufactured by Kusumoto Chemicals, Ltd.

The content of the dispersant is preferably 0.1% to 2% by mass, 0.1% to 1.5% by mass, or 0.1% to 1.0% by mass with respect to the total amount of the ink composition.

### 1. 2. 5. 4. Coloring Material

The ink composition of the present embodiment may further contain a coloring material. One kind of the coloring material may be used alone, or two or more kinds thereof may be used in combination.

The coloring material is not particularly limited, and examples thereof include pigments and dyes. One kind of the coloring material may be used alone, or two or more kinds thereof may be used in combination.

The content of the coloring material is preferably 0.5% to 15% by mass, more preferably 1.0% to 10% by mass, and still more preferably 2.0% to 7% by mass with respect to the total amount of the ink composition. When the content of the coloring material falls within the above ranges, color developability tends to be further improved.

The ink composition of the present embodiment may contain a pigment as the coloring material. The pigment is not particularly limited, and organic pigments such as an azo pigment (including azo lake, an insoluble azo pigment, a condensed azo pigment, and a chelate azo pigment, for example), a polycyclic pigment (such as a phthalocyanine pigment, a perylene pigment, a perinone pigment, an anthraquinone pigment, a quinacridone pigment, a dioxazine pigment, a thioindigo pigment, an isoindolinone pigment, and a quinophthalone pigment), a nitro pigment, a nitroso pigment, and aniline black; and inorganic pigments such as carbon black (for example, furnace black, thermal lamp black, acetylene black, and channel black), a metal oxide, a metal sulfide, and a metal chloride; and extender pigments such as calcium carbonate and talc can be used, for example.

The pigment may be added to the ink composition as a pigment dispersion liquid obtained by dispersing the pigment in water with a dispersant, or as a pigment dispersion liquid obtained by dispersing in water a self-dispersible surface-treated pigment (hereinafter also referred to as a “self-dispersible pigment”) in which a hydrophilic group has been introduced onto a pigment particle surface utilizing a chemical reaction, or by dispersing in water a pigment coated with a polymer (hereinafter also referred to as a “resin-dispersed pigment”). Among these, a self-dispersible pigment is preferably contained. By using the self-dispersible pigment, water repellency of a nozzle plate and intermittent printing stability tend to be further improved.

One kind of each of the pigment and the dispersant constituting the pigment dispersion liquid may be used alone, or two or more kinds thereof may be used in combination.

The ink composition of the present embodiment may contain a dye as the coloring material. The dye is not particularly limited, and examples thereof include acid dyes such as C.I. Acid Yellow, C.I. Acid Red, C.I. Acid Blue, C.I. Acid Orange, C.I. Acid Violet, and C.I. Acid Black; basic dyes such as C.I. Basic Yellow, C.I. Basic Red, C.I. Basic Blue, C.I. Basic Orange, C.I. Basic Violet, and C.I. Basic Black; direct dyes such as C.I. Direct Yellow, C.I. Direct Red, C.I. Direct Blue, C.I. Direct Orange, C.I. Direct Violet, and C.I. Direct Black; reactive dyes such as C.I. Reactive Yellow, C.I. Reactive Red, C.I. Reactive Blue, C.I. Reactive Orange, C.I. Reactive Violet, and C.I. Reactive Black; and disperse dyes sch as C.I. Disperse Yellow, C.I. Disperse Red, C.I. Disperse Blue, C.I. Disperse Orange, C.I. Disperse Violet, and C.I. Disperse Black. One kind of the dye may be used alone, or two or more kinds thereof may be used in combination.

### 1. 2. 5. 5. Fluorescent Brightener

The ink composition of the present embodiment may further contain a fluorescent brightener. One kind of the fluorescent brightener may be used alone, or two or more kinds thereof may be used in combination.

Fluorescent brighteners absorb light at wavelengths around 300 nm to 450 nm and emit fluorescence at wavelengths around 400 nm to 500 nm, for example. That is, when ultraviolet rays are used as radiation, the fluorescent brightener increases a long wavelength region of the ultraviolet rays with which ink is irradiated, thereby improving curability. Since the combination of the fluorescent brightener and the photoinitiator exhibits a sensitizing effect, inclusion of the fluorescent brightener tends to result in more excellent curability than the case of including only the photoinitiator.

Examples of the fluorescent brightener include a naphthalenebenzoxazolyl derivative, a thiophene benzoxazolyl derivative, a stilbene benzoxazolyl derivative, a coumarin derivative, a styrene biphenyl derivative, a pyrazolone derivative, a stilbene derivative, styryl derivatives of benzene and biphenyl, a bis(benzazol-2-yl) derivative, carbostyril, naphthalimide, a derivative of dibenzothiophene-5,5′-dioxide, a pyrene derivative, and a pyridotriazole and the like.

A commercially available product may be used as the fluorescent brightener. Examples of commercially available products include TELALUX (registered trademark) OB (2,5-bis(5-tert-butyl-2-benzoxazolyl)thiophen) and KCB (1,4-bis(2-benzoxazolyl)naphthalene) available from Clariant Japan K. K.

The content of the fluorescent brightener contained in the ink composition is preferably 0.07% to 0.70% by mass or less and 0.10% to 0.50% by mass or less with respect to the total amount of the ink composition. When the content of the fluorescent brightener falls within the above ranges, curability of the ink composition tends to be improved.

### 1. 3. Recording Medium

The primer composition of the present embodiment can be preferably used as the primer composition used in application on a recording medium in ink jet printing. The recording medium is not particularly limited, and examples thereof include an absorptive recording medium and a non-absorptive recording medium.

Examples of the absorptive recording medium include plain paper such as electrophotographic paper, ink jet paper, art paper used for general offset printing, coated paper, and cast paper.

Examples of the non-absorptive recording medium include plastics such as polyvinyl chloride (PVC), polystyrene (PS), polyethylene terephthalate (PET), polypropylene (PP), polyethylene (PE), polycarbonate, cellulose diacetate, cellulose triacetate, cellulose propionate, cellulose butyrate, cellulose acetate butyrate, cellulose nitrate, and polyvinyl acetal, and surface-treated products thereof, glass, metal, and wood.

The form of the recording medium is not particularly limited, and examples thereof include a film, a board, and a cloth.

Among these recording media, the ink composition according to the present embodiment is preferably used for a non-absorptive recording medium, and a plastic film is particularly preferable. In particular, when polyethylene terephthalate (PET), polypropylene (PP), polyethylene (PE), polyvinyl chloride (PVC), polystyrene (PS), or polyolefin (PO) is used, adhesiveness of the coating film is more excellent. Although the mechanism of this effect is not limited, it is considered that the interface between a polar resin in the ink composition and a polar recording medium acts to improve adhesiveness between the ink composition and the recording medium. In particular, polyethylene terephthalate (PET), polypropylene (PP), and polyethylene (PE) are more preferable. In addition, when the recording medium is a shrink film which shrinks when heat or the like is applied, adhesiveness of the ink composition is excellent, and processability of the recording medium is improved.

### 1. 4. Method of Producing Primer Composition

Production (preparation) of the primer composition is carried out by mixing components contained in the primer composition and stirring the mixture so that the components are sufficiently uniformly mixed. In the present embodiment, preparation of the primer composition preferably includes a step of subjecting a mixture obtained by mixing the photopolymerization initiator and at least a part of monomers to at least one of an ultrasonic treatment and a heating treatment in the preparation process. Consequently, the amount of dissolved oxygen in the primer composition after preparation can be reduced, and a primer composition having excellent ejection stability and storage stability can be obtained. The mixture may contain at least the above-mentioned components, and may further contain another component contained in the primer composition, or may contain all components contained in the primer composition. The monomers contained in the mixture may be at least a part of the monomers contained in the primer composition.

### 1. 5. Method of Producing Ink Composition

Production (preparation) of the ink composition is carried out by mixing components contained in the ink composition and stirring the mixture so that the components are sufficiently uniformly mixed. In the present embodiment, preparation of the ink composition preferably includes a step of subjecting a mixture obtained by mixing the photopolymerization initiator and at least a part of monomers to at least one of an ultrasonic treatment and a heating treatment in the preparation process. Consequently, the amount of dissolved oxygen in the ink composition after preparation can be reduced, and an ink composition having excellent ejection stability and storage stability can be obtained. The mixture may contain at least the above-mentioned components, and may further contain another component contained in the ink composition, or may contain all components contained in the ink composition. The monomers contained in the mixture may be at least a part of the monomers contained in the ink composition.

### 2. Recording Method

The recording method of the present embodiment includes applying the primer composition of the ink set according to the present embodiment onto a recording medium, curing the primer composition applied onto the recording medium to form a primer layer, winding the recording medium on which the primer layer is formed, and ejecting the ink composition of the ink set according the present embodiment onto the primer layer to attach the ink composition onto the primer layer. Note that, winding may be omitted, and the ink composition may be ejected onto the recording medium on which the primer layer is formed and attached onto the primer layer.

### 2. 1. Application Step

In the application step, the primer composition of the ink set of the present embodiment is applied onto the recording medium. Examples of the method of applying the primer composition onto the recording medium include a dip application method in which the recording medium is dipped in the primer composition, a roller application method in which the primer composition is applied by a mangle roller, a roll coater, or the like, a spray application method in which the primer composition is sprayed by a spray device or the like, and an ink jet application method in which the primer composition is sprayed by an ink jet method.

The recording medium is not particularly limited, and the above-described recording medium can be used. For the primer composition according to the present embodiment, a non-absorptive recording medium is preferable, and a plastic film is more preferable.

### 2. 2. Curing Step

In the curing step, the primer composition applied onto the recording medium is cured to form a primer layer. Examples of the method of curing the primer composition include a method of irradiating the primer composition with radiation. When the composition is irradiated with radiation, a monomer polymerization reaction is initiated, and the composition is thus cured to form a coating film. At this time, when a photopolymerization initiator is present, an active species (initiating species) such as a radical, an acid, of a base is generated, and the monomer polymerization reaction is promoted by the function of the initiating species. In addition, when a photosensitizer is present, the photosensitizer absorbs radiation and transits to an excited state, and when the photosensitizer comes into contact with the photopolymerization initiator, decomposition of the photopolymerization initiator is promoted, and thus a curing reaction can be further achieved.

Here, examples of the radiation include ultraviolet rays, infrared rays, visible light, and X-rays. A radiation source irradiates the primer composition by a radiation source provided downstream of a liquid ejection head.

The curing step may be performed in a nitrogen atmosphere. That is, the primer composition may be cured by irradiation with radiation after nitrogen purging. When the curing step is performed in a nitrogen atmosphere, a curing rate of the primer composition tends to be improved, and production efficiency tends to be improved. In addition, a primer layer in which the primer composition is more uniformly cured can be formed, adhesiveness to the ink composition is more excellent, and blocking resistance between the primer composition and the recording medium also tends to be more excellent.

### 2. 2. 1. Ultraviolet Irradiation Step

In the recording method of the present embodiment, the curing step preferably includes an ultraviolet irradiation step. In the ultraviolet irradiation step, the primer composition applied onto the recording medium is irradiated with ultraviolet rays to cure the primer composition and form a primer layer. An ultraviolet light source is not particularly limited, and examples thereof include an ultraviolet light-emitting diode (LED). By using such an ultraviolet light source, downsizing of the device and cost reduction can be achieved. The ultraviolet light-emitting diode as the ultraviolet light source is small, and can thus be attached to an ink jet apparatus.

For example, the ultraviolet light-emitting diode can be attached to a carriage (both ends along the medium width direction and/or the medium transport direction side) on which the liquid ejection head that ejects the ink composition is mounted. Furthermore, due to the composition of the primer composition described above, curing at low energy and high speed can be realized. The irradiation energy is calculated by multiplying irradiation time by irradiation intensity. Therefore, the irradiation time can be shortened, and printing speed is increased. On the other hand, the irradiation intensity can also be reduced. Consequently, increase in temperature of a printed matter can be reduced, which leads to reduction of odor of a cured film.

The thickness of the primer layer of the primer composition cured in the curing step is not particularly limited, and is preferably 10 μm or less, and particularly preferably 5 μm or less.

### 2.3. Winding Step

In the winding step, the recording medium on which the primer layer is formed is wound into, for example, a roll shape by a winding device. The winding device is not particularly limited, and a known device such as a roller can be used. In the recording method of the present embodiment, since the primer layer obtained by curing the primer composition of the present embodiment is formed on the recording medium, blocking can be suppressed when the recording medium is wound up. The recording method of the present embodiment may include the winding step after the ejection step described later, that is, the recording medium in which the ink composition of the present embodiment is attached onto the primer layer may be wound in a roll shape, for example. In addition, in the recording method of the present embodiment, the winding process may be included before and after the ejection step described later.

### 2. 4. Ejection Step

In the ejection step, the ink composition after heating is ejected from the liquid ejection head to attach the ink composition onto the primer layer. More specifically, the ink composition filling a pressure generation chamber of the liquid ejection head is ejected from a nozzle by driving a pressure generation unit. Such an ejection method is also referred to as an ink jet method. Ejection conditions in the ejection step may be appropriately adjusted depending on the physical properties of the ink composition.

### 2. 5. Curing Step

The recording method of the present embodiment may further include a curing step of curing the ink composition attached onto the primer layer. As a method of curing the ink composition, the method described above in “2. 2. Curing step” can be used.

The thickness of the coating film of the ink composition cured in the curing step is not particularly limited, and is preferably 10 μm or less, and particularly preferably 5μm or less.

### EXAMPLES

The present disclosure will be described in more detail with reference to Examples below. The present disclosure is not limited by the following Examples.

### 1. Preparation of Primer Composition (Preparation Examples 1 to 12)

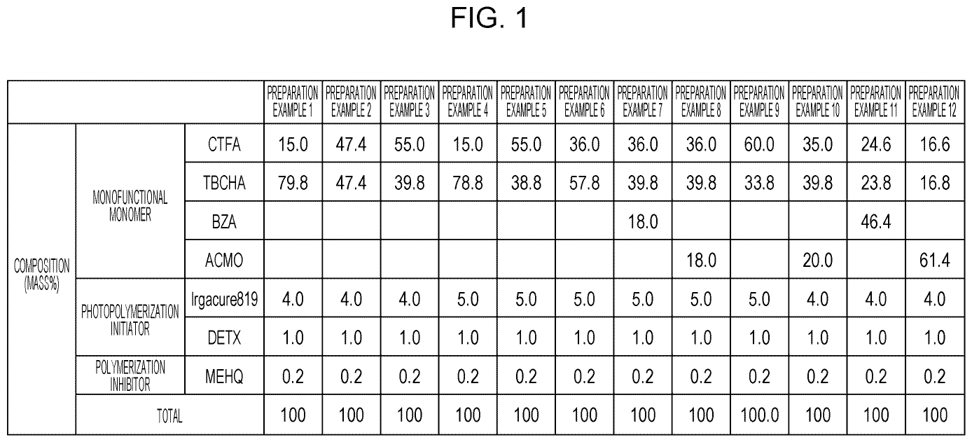

Monomers, a photopolymerization initiator, and a polymerization inhibitor are put into a mixture tank which is a stainless steel container so that each composition shown in FIG. 1 is achieved, mixed and stirred to be completely dissolved, further mixed and stirred at room temperature for 1 hour, and further filtered with a 5 μm membrane filter to obtain a primer composition of each example. Note that, the numerical value of each of the components of each example shown in the table represents mass% unless otherwise specified.

### 2. Preparation Of Ink Composition (Preparation Examples 13 to 20)

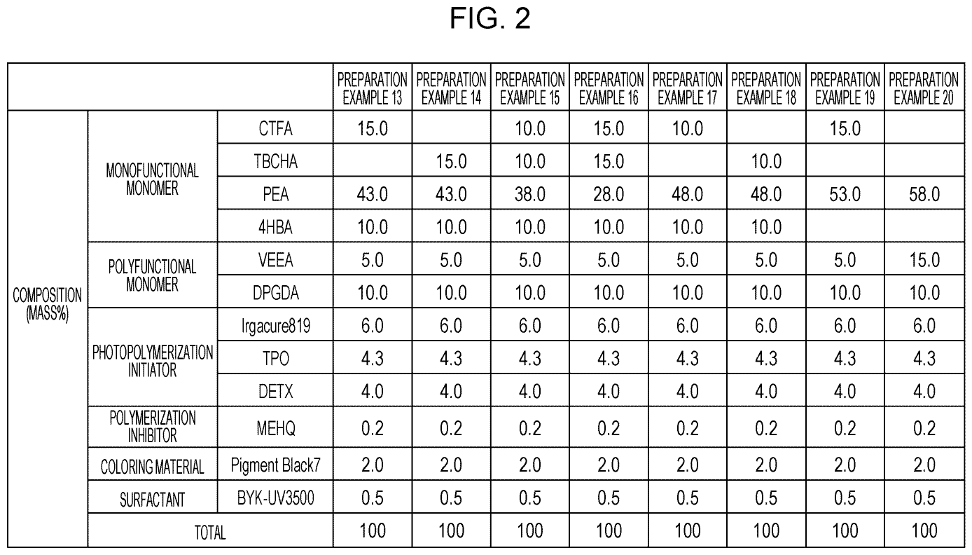

First, a coloring material and a part of monomers are weighed and put into a tank for dispersing a pigment, and a ceramic bead mill having a diameter of 1 mm is put into the tank and stirred to obtain a pigment dispersion liquid in which the coloring material is dispersed in the monomers. Next, the remaining monomers, a photopolymerization initiator, a polymerization inhibitor, and a slip agent are put into a mixture tank which is a stainless steel container so that each composition shown in FIG. 2 is achieved, and mixed and stirred to be completely dissolved, and the pigment dispersion liquid obtained above is introduced, which is further mixed and stirred at room temperature for 1 hour, and further filtered with a 5 μm membrane filter to obtain the ink composition of each example. Note that, the numerical value of each of the components of each example shown in the table represents mass% unless otherwise specified.

Abbreviations and components of products used in FIG. 1 and FIG. 2 are as follows.

### Monomers

CTFA (product name: “Viscoat #200,” manufactured by OSAKA ORGANIC CHEMICAL INDUSTRY LTD., cyclic trimethylolpropane formal acrylate)
TBCHA (tert-butyl cyclohexanol acrylate, manufactured by KJ Chemicals Corporation)
ACMO (acryloylmorpholine manufactured by KJ Chemicals Corporation)
PEA (product name: “Viscoat #192,” manufactured by OSAKA ORGANIC CHEMICAL INDUSTRY LTD., phenoxyethyl acrylate”) 4HBA (Mitsubishi Chemical Corporation, 4-hydroxybutyl acrylate)
VEEA (2-(2-vinyloxyethoxy)ethyl acrylate, manufactured by NIPPON SHOKUBAI CO., LTD.)
DPGDA (product name: “SR508,” dipropylene glycol, manufactured by SARTOMER Company

### Photopolymerization Initiator

Irgacure 819 (product name: “IRGACURE 819,” bis(2,4,6-trimethylbenzoyl)-phenylphosphine oxide, manufactured by BASF SE)
TPO (product name: “IRGACURE TPO,” 2,4,6-trimethylbenzoyl diphenylphosphine oxide, manufactured by BASF SE)
DETX (product name: “Speedcure DETX,” 2,4-diethylthioxanthone, manufactured by Lambson Ltd.)

### Polymerization Inhibitor

MEHQ (product name: “p-methoxyphenol,” hydroquinone monomethyl ether, manufactured by Kanto Chemical Co., Inc.)

### Slip Agent

BYK-UV3500 (a polyether-modified polydimethylsiloxane having an acryloyl group, manufactured by BYK Additives & Instruments)
   Coloring material

### Pigment Black 7

### 3. Evaluation Methods

### 3. 1. Evaluation of Adhesiveness

The primer composition of each of Preparation Examples is applied onto a polypropylene film (FOS-BT (product number), manufactured by Futamura Chemical Co., Ltd.) using a bar-coater in an amount to give a film thickness of 4 μm (film thickness after curing), subjected to nitrogen purging, and then cured by irradiation with ultraviolet rays with energy of 300 mJ/cm² to form a primer layer. At this time, an LED having a peak wavelength at 395 nm is used as a light source. Subsequently, the ink composition of each of Preparation Examples is ejected onto the primer layer using a printer equipped with an LED (PX-G5000 modified machine, manufactured by Seiko Epson Corporation), subjected to nitrogen purging, and irradiated with ultraviolet rays with energy of 400 mJ/cm² to cure the ink composition, thereby producing a recorded matter. At this time, the ink forms a solid image of 20 ng/dot and 600 dpi×600 dpi at a duty ratio of 100%.

The recorded matter is evaluated by a cross-cut method in accordance with JIS K5600-5-6.

To be specific, a blade of a cutting tool is brought into contact with the cured film so as to be perpendicular to the cured film, squares are formed so that the distances between adjacent incisions are 2 mm to form a 5×5 grid pattern with a cutter, a transparent adhesive tape (25 mm width) having a length of about 75 mm is attached, and the tape is sufficiently rubbed with a finger so that the cured film is visible through. Next, within 5 minutes from the attachment of the tape, the tape is reliably peeled off from the cured film at an angle close to 60° over 0.5 to 1.0 seconds, and the state of the grid pattern is visually observed. The evaluation criteria are as follows. Ratings A, B, and C are considered as acceptable, and D is considered as unacceptable.
A: No delamination of the grid pattern is observed.
B: The number of squares peeled is 1 to 5.
C: The number of squares peeled is 6 to 14.
D: The number of squares peeled is 15 to 25.

### 3. 2. Evaluation of Adhesiveness After Standing at Room Temperature for 2 Weeks

A recorded matter produced by the same method as in “3. 1. Evaluation of adhesiveness” above is allowed to stand in an environment of 23° C. and 50% for 2 weeks, and after the standing, evaluation by the cross-cut method is performed in the same manner as described above.

### 3. 3. Evaluation of Blocking Resistance

The state of the primer layer prepared by the same method as in “3. 1. Evaluation of adhesiveness” above is observed visually by applying a cotton swab to the surface of the primer layer at an angle of 45° with a load of 100 g while reciprocating the cotton swab in the horizontal direction over 5 cm within 2 seconds. The evaluation criteria are as follows. Ratings A, B, and C are considered as acceptable, and D is considered as unacceptable.
A: No change is observed in the primer cured film. (no apparent deformation)
B: A thin scratch is observed in an area of one-quarter or less of the portion rubbed with the cotton swab. (no apparent deformation)
C: A cloudy scratch is observed in an area of one-quarter or more and one-half or less of the portion rubbed with the cotton swab. (with apparent deformation)
D: One-half or more of the portion rubbed with the cotton swab is destroyed or peeled off. (with obvious deformation)

### 4. Evaluation Results

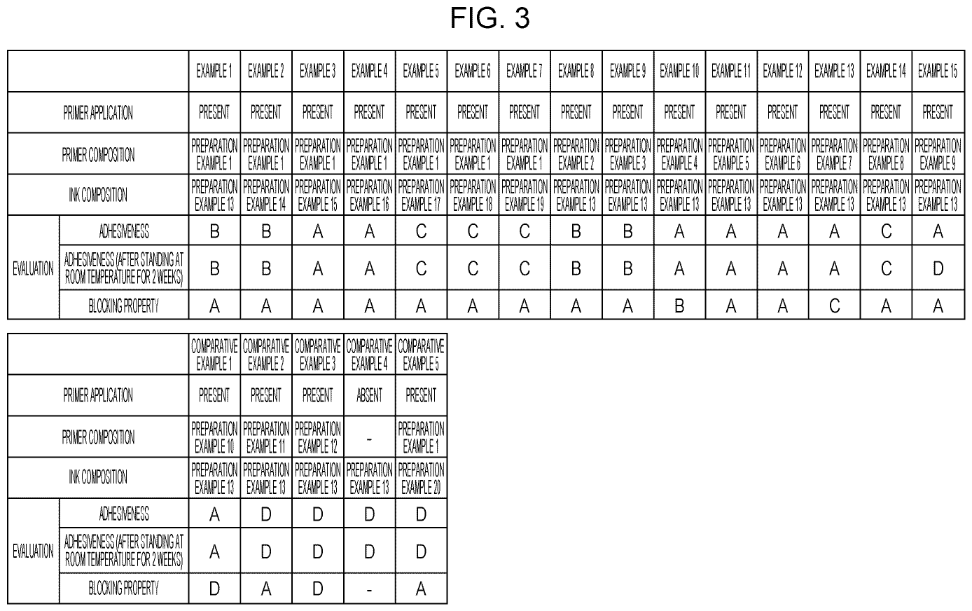

FIG. 3 shows evaluation results when the primer compositions of respective Preparation Examples and the ink compositions of respective Preparation Examples were used. From FIG. 3, the combination of the primer composition containing 80% by mass or more of the compound (A) with respect to the total amount of the polymerizable compounds and the ink composition containing the compound (A) is excellent in both adhesiveness and blocking resistance.

Specifically, when each Example is compared with Comparative Examples 1 to 3, Comparative Examples 1 to 3 using the primer composition in which the content of the compound (A) is less than 80% by mass have revealed that each Example can achieve both adhesiveness and blocking resistance.

In addition, when each Example is compared with Comparative Example 4, it is shown that Comparative Example 4 in which the primer composition is not applied is inferior in adhesiveness of the ink composition.

Further, when each Example is compared with Comparative Example 5, it is shown that adhesiveness is inferior in the combination of the ink composition not containing the compound (A) and the primer composition containing the compound (A).

In addition, when Examples 1 to 14 are compared with Example 15, it is shown that Examples 1 to 14 in which the content of the ether ring-containing polymerizable compound (A-1) is 60% by mass or less are also excellent in adhesiveness after being left to stand at room temperature for 2 weeks.

What is claimed is:

1. An ink set comprising:
a primer composition; and
an ink composition, wherein
the primer composition contains at least one kind of compound (A) selected from an ether ring-containing polymerizable compound (A-1) and a saturated hydrocarbon ring-containing polymerizable compound (A-2),
a content of the compound (A) in the primer composition is 80% by mass or more with respect to a total amount of polymerizable compounds, and
the ink composition contains the compound (A).

2. The ink set according to claim 1, wherein
the primer composition contains the ether ring-containing polymerizable compound (A-1) and the saturated hydrocarbon ring-containing polymerizable compound (A-2).

3. The ink set according to claim 1, wherein
a content of the ether ring-containing polymerizable compound (A-1) in the primer composition is 15% by mass or more and 60% by mass or less with respect to the total amount of the polymerizable compounds.

4. The ink set according to claim 1, wherein
a content of the saturated hydrocarbon ring-containing polymerizable compound (A-2) in the primer composition is 38% by mass or more and 85% by mass or less with respect to the total amount of the polymerizable compounds.

5. The ink set according to claim 1, wherein
a content of a surfactant in the primer composition is 0% by mass or more and 0.1% by mass or less with respect to a total amount of the primer composition.

6. The ink set according to claim 1, wherein
the primer composition further contains an aromatic ring-containing monomer and/or a nitrogen-containing heterocycle-containing monomer.

7. The ink set according to claim 1, wherein
a content of a photopolymerization initiator in the primer composition is 5% by mass or more with respect to a total amount of the primer composition.

8. The ink set according to claim 1, wherein
a content of the compound (A) in the ink composition is 15% by mass or more with respect to a total amount of the ink composition.

9. The ink set according to claim 1, wherein
a content of a monofunctional monomer in the ink composition is 60% by mass or more with respect to the total amount of the polymerizable compounds.

10. The ink set according to claim 1, wherein
the ink composition further contains a thioxanthone-based initiator and/or an acylphosphine oxide-based initiator.

11. The ink set according to claim 1, wherein
the ink composition further contains a hydroxy group-containing monomer.

12. A recording method comprising:
applying the primer composition of the ink set according to claim 1 onto a recording medium;
curing the primer composition applied onto the recording medium to form a primer layer;
winding the recording medium on which the primer layer is formed; and
ejecting the ink composition of the ink set according to claim 1 onto the primer layer to attach the ink composition onto the primer layer.

13. The recording method according to claim 12, wherein
the primer composition applied onto the recording medium is cured by ultraviolet irradiation.
